(19) United States
(12) Patent Application Publication
(10) Pub. No.: US 2020/0005303 A1
(43) Pub. Date: Jan. 2, 2020

(54) AUTOMATIC PAYROLL PROCESSOR

(71) Applicant: ADP, LLC, Roseland, NJ (US)

(72) Inventors: LEONARD KIM, SOUTH PASADENA, CA (US); HAIFENG LI, JOHNS CREEK, GA (US); KUNAL SAWARKAR, FRANKLIN PARK, NJ (US)

(21) Appl. No.: 16/025,341

(22) Filed: Jul. 2, 2018

(51) Int. Cl. G06Q 20/40; G06N 99/00

(52) U.S. Cl. CPC G06Q 20/407; G06N 99/005

(57) ABSTRACT

Aspects of the present invention provide devices that process cancelling an automatic payroll payment for an employee pay by, in response to a termination request terminating employment of an employee from an entity, determining a recommendation to cancel the automatic payroll pay according to a trained classification model and a feature vector for the employee termination. The devices train the trained classification model on prior decisions for cancelling automatic payroll payments for terminated employees and corresponding feature vectors, and display the recommendation to cancel the automatic payroll pay on a display device.

### BACKGROUND

The field of Human Capital Management (HCM) includes payroll processing of automatic payments to employees.

Employees are typically paid on an automatic basis according to a position, rate and pay period determined by an entity, such as a company or an organization. Regular payments are made at each pay period, such as biweekly, semi-monthly, or monthly. Automatic pay continues unless canceled. In processing a last pay at termination, whether voluntary or involuntary, an issue arises relative to timing of cancelling automatic payments. At a time of notice of termination, particularly within a pay period, a last pay can be processed using the automatic pay, or the automatic pay canceled and the last pay prepared separately.

If automatic payment is not cancelled at a time of termination, terminated employees can continue to be paid for the entire cycle, which may result in overpayment that is typically a loss for the entity. If automatic payment is cancelled at a time of termination, circumstances surrounding the termination may result in under payment, unnecessary manual processing, violation of contract terms, violation of statute, animus towards the entity, and combinations thereof.

A conventional approach to mitigate problems of whether to cancel automatic payment within a pay period is for the entity to request terminations to coincide with an end of a pay period. That is, if feasible termination dates are moved to co-terminate with an end of a pay period, and automatic payment ends with an end of a pay cycle.

### BRIEF SUMMARY

In one aspect of the present invention, a computer-implemented method for cancelling an automatic payroll payment for an employee pay includes executing on a computer processor in response to a termination request terminating employment of an employee from an entity, determining a recommendation to cancel the automatic payroll pay according to a trained classification model and a feature vector for the employee termination. The trained classification model is trained on prior decisions for cancelling automatic payroll payments for terminated employees and corresponding feature vectors. The recommendation to cancel the automatic payroll pay is displayed on a display device.

In another aspect, a system has a hardware processor, computer readable memory in circuit communication with the processor, and a computer-readable storage medium in circuit communication with the processor and having program instructions stored thereon. The processor executes the program instructions stored on the computer-readable storage medium via the computer readable memory and thereby cancelling an automatic payroll payment for an employee pay, which in response to a termination request terminating employment of an employee from an entity, determines a recommendation to cancel the automatic payroll pay according to a trained classification model and a feature vector for the employee termination. The trained classification model is trained on prior decisions for cancelling automatic payroll payments for terminated employees and corresponding feature vectors. The processor displays the recommendation to cancel the automatic payroll pay on a display device.

In another aspect, a computer program product for cancelling an automatic payroll payment for an employee pay has a computer-readable storage medium with computer readable program code embodied therewith. The computer readable hardware medium is not a transitory signal per se. The computer readable program code includes instructions for execution by a processor that cause the processor to, in response to a termination request terminating employment of an employee from an entity, determine a recommendation to cancel the automatic payroll pay according to a trained classification model and a feature vector for the employee termination. The trained classification model is trained on prior decisions for cancelling automatic payroll payments for terminated employees and corresponding feature vectors. The computer readable program code includes instructions for execution by the processor that cause the processor to display the recommendation to cancel the automatic payroll pay on a display device.

### BRIEF DESCRIPTION OF THE DRAWINGS

These and other features of embodiments of the present invention will be more readily understood from the following detailed description of the various aspects of the invention taken in conjunction with the accompanying drawings in which:

FIG. 1 depicts a schematic illustration of system aspects according to an embodiment of the present invention.

FIG. 2 is a flow chart illustration of an embodiment of the present invention.

FIG. 3 depicts an example user interface according to an embodiment of the present invention.

### DETAILED DESCRIPTION

The present invention may be a system, a method, a computer program product, and combinations thereof. The computer program product may include a computer readable storage medium (or media) having computer readable program instructions thereon for causing a processor to carry out aspects of the present invention.

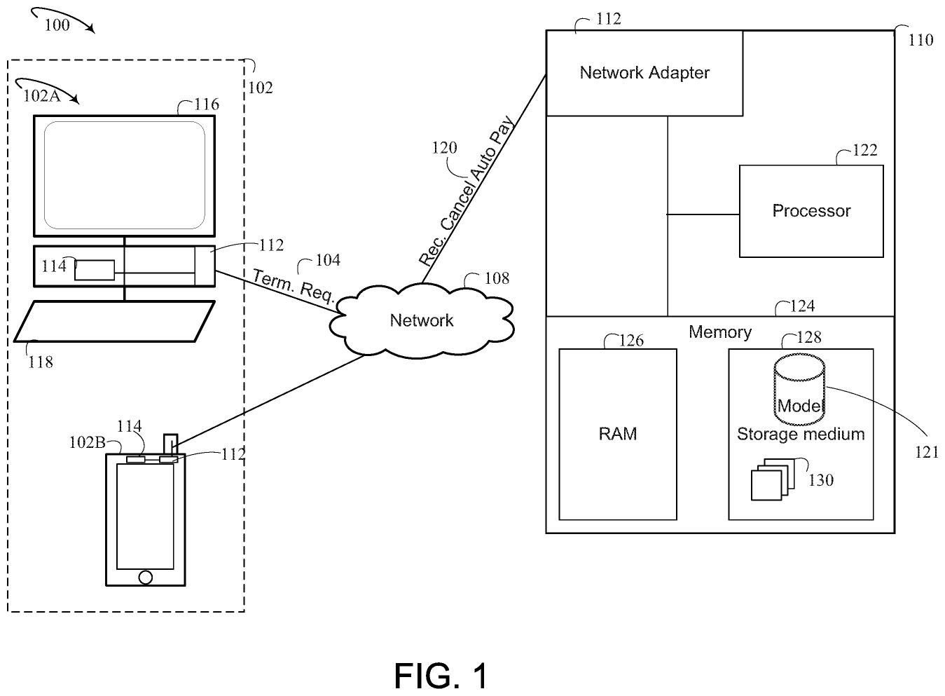

With reference to FIG. 1, a schematic of an embodiment of a system 100 for cancelling an automatic payroll payment for an employee pay is depicted. The system 100 includes a local computing device 102, such as, for example, a desktop computer 102A, laptop computer, personal digital assistant, tablet, smartphone 102B, cellular telephone, body worn device, and the like. The system 100 identifies an employee employed by an entity, and paid by automatic payroll pay according to a pay period, such as a bi-weekly, semi-monthly, monthly, and the like. The local computing device 102 receives a termination request 104 terminating employment of an employee from an entity.

The termination request 104 includes an identifier of the employee and a date on which employment is terminated, such as a last day of work. The date on which employment is terminated is independent of an end of the pay period. The termination request 104 includes an indicator of a termination type for the employee, such as voluntary or involuntary termination. In some embodiments, the termination type can include a reason code, which further delineates the termination type, or provides finer categories of reasons for the termination. For example, reasons can include resignation, retirement, layoff and firing.

The local computing device 102 transfers the termination request 104 over a network 108 to a computer server 110. The local computing device 102 includes a network interface adapter 112, a processor 114, a display device 116 and one or more input devices 118, such as a keyboard, touch screen, mouse, microphone, and the like. The local computing device 102 can include displays on the display device 116 and inputs from the input devices 118 to identify the employee, enter the termination request 104 for the employee through a user interface, and transfer the termination request 104 to the computer server 110.

The computer server 110, in response to the termination request 104, determines a recommendation to cancel the automatic payroll pay for the employee 120 according to a trained classification model 121 and a feature vector for the employee. The trained classification model is trained on prior decisions for cancelling automatic payroll payments for terminated employees and corresponding feature vectors.

The recommendation to cancel the automatic payroll pay for the employee 120 can be represented as a binary value with a first value recommending to cancel the automatic payroll pay for the employee as of the date included in the termination request 104, and a second value recommending to continue the automatic payroll pay for the employee past the date included in the termination request 104. For example, cancelling the automatic payroll pay for the employee as of the date included in the termination request 104 can mean manual or alternative processing of a last pay for an employee, and not cancelling the automatic payroll pay for the employee continues the automatic payroll pay to the employee according to the pay period which can mean pay delivery according to pay parameters and normal operational cycles.

The computer server 110 returns the recommendation to cancel the automatic payroll pay for the employee 120 to the local computing device 102. The local computing device 102 displays the recommendation to cancel the automatic payroll pay for the employee 120 on the display device 120.

The lines of the schematic illustrate communication paths between devices and between components with each device. Communication paths between the local computing device 102 and the computer server 110 over the network 108 include a network interface device 112 in each device, such as a network adapter, network interface card, wireless network adapter, and the like.

The computer server 110 includes a processor 122 configured with instructions stored in a memory 124. The processor 122 of the computer server 110 and the processor 114 of the local computing device include, for example, a digital processor, an electrical processor, an optical processor, a microprocessor, a single core processor, a multi-core processor, distributed processors, parallel processors, clustered processors, combinations thereof and the like. The memory 124 includes a computer readable memory 126 and a computer readable storage medium 128.

The computer readable storage medium 128 can be a tangible device that retains and stores instructions for use by an instruction execution device, such as the processor 122. The computer readable storage medium 128 may be, for example, but is not limited to, an electronic storage device, a magnetic storage device, an optical storage device, an electromagnetic storage device, a semiconductor storage device, or any suitable combination of the foregoing. A computer readable storage medium 128, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be transmitted to respective computing/processing devices from the computer readable storage medium 128 or to an external computer or external storage device via the network 108. The network 108 can include private networks, public networks, wired networks, wireless networks, data networks, cellular networks, local area networks, wide area networks, the Internet, and combinations thereof. The network interface device 112 in each device receives computer readable program instructions from the network 108 and forwards the computer readable program instructions for storage in the computer readable storage medium 128 within the respective computing/processing device.

Computer readable program instructions for carrying out operations of the present invention may include assembler instructions, instruction-set-architecture (ISA) instructions, machine instructions, machine dependent instructions, microcode, firmware instructions, state-setting data, configuration data for integrated circuitry, compiled or interpreted instructions, source code or object code written in any combination of one or more programming languages or programming environments, such as Java® (Java is a registered trademark of Oracle America, Inc.), Javascript, C, C#, C++, Python, Cython, F#, PHP, HTML, Ruby, and the like.

The computer readable program instructions may execute entirely on the computer server 110, partly on the computer server 110, as a stand-alone software package, partly on the computer server 110 and partly on the local computing device 102 or entirely on the local computing device 102. For example, the local computing device 102 can include a web browser that executes HTML instructions transmitted from the computer server 110, and the computer server executes Java® instructions that construct the HTML instructions. In another example, the local computing device 102 includes a smartphone application, which includes computer readable program instructions to enter and transfer of the termination request 104, and the computer server 110 includes different computer readable program instruction to receive and process the transferred termination request 104.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine (“a configured processor”), such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The memory 124 can include a variety of computer system readable media. Such media may be any available media that is accessible by computer server 110, and the media includes volatile media, non-volatile media, removable, non-removable media, and combinations thereof. Examples of the volatile media can include random access memory (RAM) and/or cache memory. Examples of non-volatile memory include magnetic disk storage, optical storage, solid state storage, and the like. As will be further depicted and described below, the memory 124 can include at least one program product having a set (e.g., at least one) of program modules 130 that are configured to carry out the functions of embodiments of the invention.

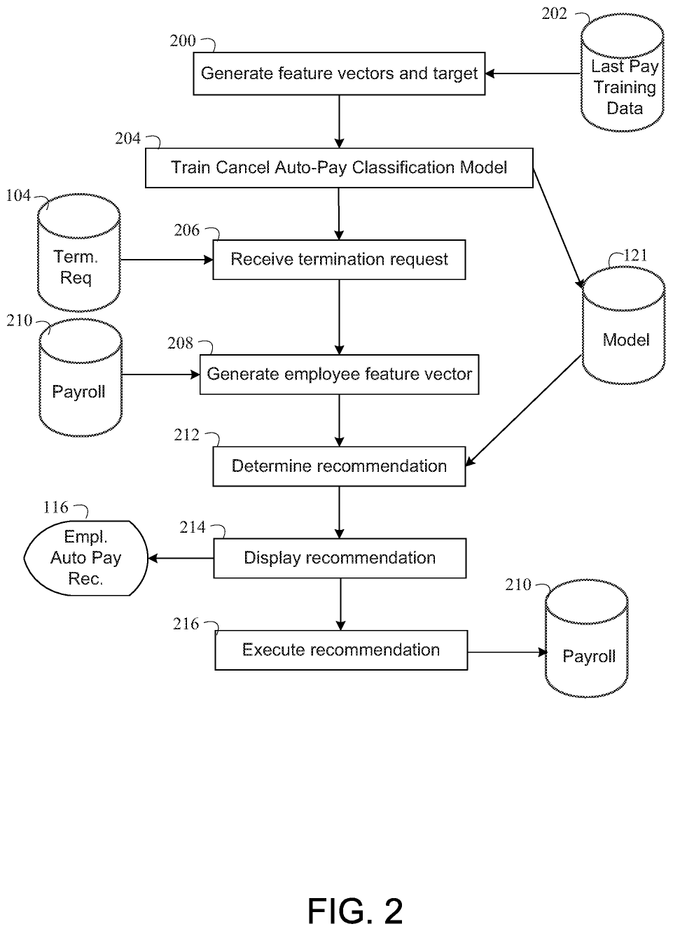

FIG. 2 illustrates one embodiment of a method according to the present invention for cancelling an automatic payment for an employee pay. At 200, a processor that is configured according to an aspect of the present invention (the “configured processor”) generates feature vectors and targets from a collection of prior decisions for cancelling automatic payroll payments for terminated employees 202. The collection of prior decisions for cancelling automatic payroll payments for terminated employees 202 includes a representative sampling of data for each attribute of the feature vector. The representative sampling of prior decisions includes a plurality of entities, a plurality of states and a plurality of industries. The representative sampling of prior decisions can include terminations over time, such as, a plurality of years.

The attributes of the feature vectors include a variation index of entity policy for cancelling automatic payments for employees, a termination type for the employee from the entity, a state indicator that indicates a type of state in which the employee is employed, a number of days from a last pay period end date for the employee, a time indicator that indicates time reporting for payroll processing by the employee, a union indicator for the employee, an industry indicator, a group event indicator, seasonal indicator, a weekday indicator, and combinations thereof. The attributes of the feature vector can include a mapping between values indicative of employment for employees by corresponding entities.

The variation index of entity policy for cancelling automatic payments for employees is computed as a fraction of prior decisions that cancel automatic pay processing on a date of termination in response to a termination request. The fraction can be represented as values in the interval [0,1]. For example, a value of 0 can represent an entity policy that automatic pay processing is either always cancelled or never cancelled for all employees as of the date of the termination request for the past year. That is, there is no variation in the cancelling of automatic payroll pay for employees by the entity. A value of 1 can represent an entity policy that automatic pay processing varies randomly, such as 50% of employee terminations result in cancelling automatic payroll pay for the terminated employee, and 50% of employee terminations automatic payroll pay continues through a last payroll cycle for the terminated employee.

The termination type for the employee from the entity can be represented as a binary value, which includes a value for voluntary termination and a value for involuntary termination. Reasons can be mapped to the termination type. For example, a value indicating resignation and a value indicating retirement can be mapped to the value for voluntary termination.

The state indicator indicates a type of state in which the employee is employed. The state indicator can be mapped from a value indicating the state, such as “OH” for “Ohio” to the state indicator, which can include one or more states for each state indicator. For example, states which have similar limitations to at-will employment, such as public policy exemptions, implied contract exemptions and covenant of good faith exemptions can be mapped to a same state indicator.

The time indicator indicates time reporting for payroll processing by the employee, which can be expressed as a binary value. For example, employees that log or report time for work, whether exempt or non-exempt, whether negative pay or positive pay, can be represented as one binary value and employees that do not log time can be represented as the other binary value. The binary value can include a blank or null value.

The union indicator for the employee indicates whether or not the employee is a member of a labor union. The mapping can include mapping union names or union identifiers to the union indicator.

The industry indicator indicates a type of industry in which the employee is employed. In some embodiments, the industry indicator can be based on industry classifications, such as North American Industry Classification System (NAICS), Industry Classification Benchmark (ICB), Standard International Trade Classification (SITC), and the like. In some embodiments, the industry indicator indicates the industry of the type of work performed by the employee, such as engineering, marketing, sales, etc. The industry indicator includes a plurality of values, each representing a different type of industry. In some embodiments, values of the industry indicator are mapped from a plurality of industries to a single value of the industry indicator.

The group event indicator indicates if the termination is one of a predetermined number of concurrent employee terminations. The concurrent terminations can include voluntary terminations, involuntary terminations, and combinations thereof. For example, employees terminated in a mass layoff can be indicated with a first value and an employee terminated in a single event is indicated with a second value.

The seasonal indicator indicates the season of the termination. For example, values for the season at the time of termination can be indicated as separate values for fall, winter, spring, and summer. In some embodiments, the values for the indicator can include values for months of the year.

The weekday indicator indicates values for the day of the week, such as values of Monday, Tuesday, Wednesday, Thursday, Friday, Saturday, Sunday. In some embodiments, the weekday indicator indicates a normal last work day in the work week for the employee. For example, if the employee normally works Tuesday through Saturday, then the workday indicator can include a first value for days Tuesday through Friday, and a second value for Saturday. In another example, the days of the work week for the employee are numbered, such as 1 for a first day, 2 for a second day, etc.

The target values include a first value which represents cancelling the automatic pay as of the date of termination and a second value which represents continuing the automatic pay past the date of termination, e.g. to the end of the pay period. In some embodiments, the target values and corresponding feature vectors include target values of decisions validated as proper and exclude target value decisions determined as improper.

At 204, the configured processor trains the classification model 121 with the generated feature vectors and targets from prior decisions for cancelling automatic payroll payments for terminated employees. The classification model 121 includes a decision tree structure and an algorithm for classifying the attributes of the feature vectors according to the targets, such as an ID3 algorithm, a C4.5 algorithm, a C5.0 algorithm and the like. Each node in the tree structure represents the classification of one attribute of the feature vector. At each node of the tree structure, the algorithm chooses data of one attribute that most effectively splits the feature vectors and targets into classes according to a normalized information gain or a difference in information entropy. Information entropy is defined as an average amount of information produced by a stochastic source of the feature vectors and targets. Information gain is defined as an expected value of the Kielback-Leibler divergence of a univariate probability. The attribute with the highest information gain is selected. The algorithm proceeds recursively with a next level node and subsets of the feature vectors and targets.

In some embodiments, the classification model 121 includes a decision tree structure that is composed into a set of rules. In some embodiments, the algorithm includes the C5 algorithm and includes pessimistic pruning, such as removing leaves in a lowest most branch with two leaves or less. The pessimistic pruning can provide smaller decision trees, which are more memory efficient and can provide faster processing. The C5 algorithm can include gradient boosting, which generates and compares a plurality of alternate decision tree structures or sets of rules.

The classification model 121 includes a n-fold cross validation of the generated feature vectors and targets, such as a 10-fold cross validation, where n is an integer. The 10 fold cross validation divides the feature vectors and targets into 10 disjoint subsets. Training is performed separately on each of the 10 disjoint subsets. Each of the resulting 10 trained models is compared to select a best model of the 10 trained models as the classification model 121. That is, the cross validation can produce a set of n weak learning models from a strong learning model is selected.

At 206, the configured processor receives the termination request 104. The termination request 104 includes an identifier of the employee, such as a name, employee number, tax identification number, etc., and a termination date. In some embodiments, the termination request 104 includes only termination data and the identifier of the employee is omitted.

At 208, the configured processor generates a feature vector for the employee termination. The configured processor can include data from a payroll system 210 or other system to generate the feature vector. For example, the identifier of the employee can be used to retrieve an end date of a last pay period for the employee and compute the attribute of the number of days from the last pay period end date to the termination date. The configured processor can map data from the payroll system 210 or other system to generate the attributes of the feature vector, which represent attributes of employment for the employee. In some embodiments, where the employee is not identified, the feature vector for the employee termination is generated from the received termination data.

At 212, the configured processor determines the recommendation to cancel the automatic payroll pay 120 according to the trained classification model 121 and the feature vector for the identified employee termination. The trained classification model 121 classifies attributes of the feature vector for the employee into one of two recommendations. A first recommendation is to cancel the automatic payment as of the termination date. A second recommendation is to continue the automatic payment past the termination date. The recommendation can be stored as a binary value.

Determining a recommendation to cancel the automatic payroll pay using the trained classification model 121 provides flexibility to cancel the automatic pay over the conventional practice of moving the termination date to co-terminate with an end of a pay cycle. That is, the termination date can be independent of the pay cycle. Moreover, the flexibility can also provide potential cost savings, e.g. not paying for a full cycle when work is completed only for a partial cycle.

At 214, the configured processor displays the recommendation to cancel the automatic payroll pay 120 on the display device 116. The recommendation to cancel the automatic payroll pay 120 can be represented with text, graphics and combinations thereof.

At 216, the configured processor, in response to an input from the input device 118 and the displayed recommendation to cancel the automatic payroll pay 120, can cancel the automatic payroll pay for the employee by modifying parameters of the payroll system 210.

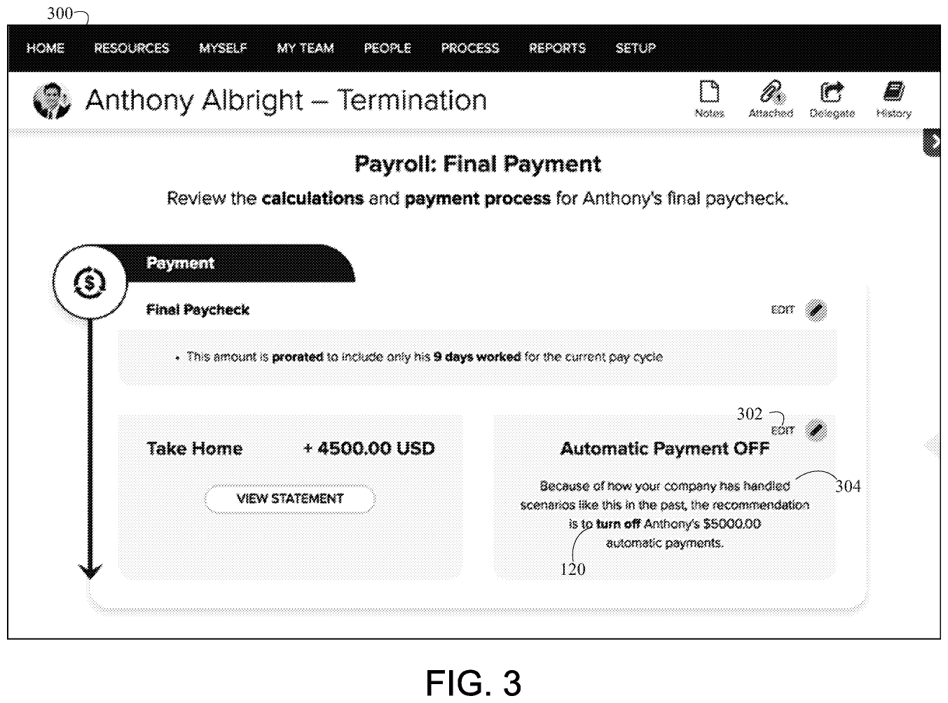

FIG. 3 depicts an example user interface according to an embodiment of the present invention, which displays a final payroll payment window 300 on the display device 116 with the recommendation to cancel the automatic payroll pay 120. The recommendation to cancel the automatic payroll pay 120 is represented with the text “the recommendation is to turn off.” Alternatively, the recommendation to cancel the automatic payroll pay can include continuing the automatic payroll processing through a final payroll cycle and past the termination date. For example, the displayed text can include “the recommendation is to continue the automatic payment through the last pay cycle.” The recommendation to cancel the automatic payroll pay 120 can include cancelling the automatic payroll pay, i.e. changing the payroll system payment parameters, such that automatic payment is discontinued. The example final payroll window 300 includes a cancelling change indicator 302, such as a selectable region with icon labeled “EDIT.” Selecting the cancelling change indicator 302 using the input device 118 can allow changing of the recommended cancelling of the automatic pay processing for the employee. That is, the edit provides for an override of the recommendation to cancel the automatic payroll pay 120. Other techniques to indicate the recommendation to cancel the automatic payroll pay 120 can include icons, coloring, highlighting, etc.

Further processing, such as, for example manual processing of a final payment, viewing a statement of income and deductions for a current cycle, etc., can include another input command.

The recommendation to cancel the automatic payroll pay 120 can include an explanation 304, which, for example, is represented by the text “Because of how your company has handled scenarios like this in the past”. In some embodiments, the display or a further input from the input device 118 can display one or more the values of the feature vector for the employee termination, one or more of the data mapped to provide the values of the feature vector for the employee termination, an explanation of one or more attributes of the feature vector for the employee termination and the trained classification model 121, and combinations thereof.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification specify the presence of stated features, integers, steps, operations, elements, and/or components, but do not preclude the presence or addition of one or more other features, integers, steps, operations, elements, components, and/or groups thereof. Certain examples and elements described in the present specification, including in the claims, and as illustrated in the figures, may be distinguished, or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations, or process steps.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for cancelling an automatic payroll payment for an employee pay, comprising executing on a computer processor:
in response to a termination request terminating employment of an employee from an entity, determining a recommendation to cancel the automatic payroll pay according to a trained classification model and a feature vector for the employee termination, wherein the trained classification model is trained on prior decisions for cancelling automatic payroll payments for terminated employees and corresponding feature vectors; and
displaying the recommendation to cancel the automatic payroll pay on a display device.

2. The method of claim 1, wherein the prior decisions for cancelling automatic payroll payments for terminated employees comprise decisions for a plurality of entities, a plurality of states, and a plurality of industries.

3. The method of claim 1, wherein the feature vector for the employee termination comprises at least one attribute selected from a group consisting of a variation index of entity policy for cancelling automatic payments for employees, a termination type for the employee from the entity, a state indicator that indicates a type of state in which the employee is employed, a number of days from a last pay period end date for the employee, a time indicator that indicates time reporting for payroll processing by the employee, a union indicator for the employee, an industry indicator, a group event indicator, a seasonal indicator, and a weekday indicator.

4. The method of claim 1, further comprising:
mapping at least one attribute of employment for the employee by the entity to attributes of the feature vector for the employee termination.

5. The method of claim 4, wherein the mapping comprises:
computing a variation index of entity policy for cancelling automatic payments for employees that represent a fraction of prior decisions that cancel automatic pay processing on a date of termination, wherein the date of termination is independent of an end of pay period for the employees.

6. The method of claim 1, wherein the trained classification model comprises a C5 algorithm which classifies attributes of the feature vector of the employee termination into one of two recommendations and the two recommendations include a first recommendation to cancel the automatic payment as of a date of termination and a second recommendation to continue the automatic payment past the date of termination.

7. The method of claim 6, wherein the trained classification model comprises a C5 algorithm trained using at least a 10 fold cross-validation of the prior decisions for cancelling automatic payroll payments for terminated employees and corresponding feature vectors.

8. The method of claim 6, wherein the C5 algorithm pessimistically prunes the decision tree structure by removing the lowest most branches with two or less leaves, wherein the C5 algorithm comprises a gradient boost which generates and compares a plurality alternate decision tree structures.

9. A system for cancelling an automatic payroll payment for an employee pay, comprising:
a processor;
a computer readable memory in circuit communication with the processor; and
a computer readable storage medium in circuit communication with the processor;
wherein the processor executes program instructions stored on the computer-readable storage medium via the computer readable memory and thereby:
in response to a termination request terminating employment of an employee from an entity, determines a recommendation to cancel the automatic payroll pay according to a trained classification model and a feature vector for the employee termination, wherein the trained classification model is trained on prior decisions for cancelling automatic payroll payments for terminated employees and corresponding feature vectors; and
displays the recommendation to cancel the automatic payroll pay on a display device.

10. The system of claim 9, wherein the prior decisions for cancelling automatic payroll payments for terminated employees comprise decisions for a plurality of entities, a plurality of states, and a plurality of industries.

11. The system of claim 9, wherein the feature vector for the employee termination comprises at least one attribute selected from a group consisting of a variation index of entity policy for cancelling automatic payments for employees, a termination type for the employee from the entity, a state indicator that indicates a type of state in which the employee is employed, a number of days from a last pay period end date for the employee, a time indicator that indicates time reporting for payroll processing by the employee, a union indicator for the employee, an industry indicator, a group event indicator, seasonal indicator, a weekday indicator.

12. The system of claim 9, wherein the processor executes program instructions stored on the computer-readable storage medium via the computer readable memory and thereby:
maps at least one attribute of employment for the employee by the entity to attributes of the feature vector for the employee termination.

13. The system of claim 12, wherein the processor executes program instructions stored on the computer-readable storage medium via the computer readable memory and thereby:
computes a variation index of entity policy for cancelling automatic payments for employees that represent a fraction of prior decisions that cancel automatic pay processing on a date of termination, wherein the date of termination is independent of an end of pay period for the employees.

14. The system of claim 13, wherein the trained classification model comprises a C5 algorithm which classifies attributes of the feature vector of the employee termination into one of two recommendations and the two recommendations include a first recommendation to cancel the automatic payment as of a date of termination and a second recommendation to continue the automatic payment past the date of termination.

15. A computer program product for cancelling an automatic payroll payment for an employee pay, the computer program product comprising:
a computer readable storage medium having computer readable program code embodied therewith, wherein the computer readable storage medium is not a transitory signal per se, the computer readable program code comprising instructions for execution by a processor that causes the processor to:
in response to a termination request terminating employment of an employee from an entity, determine a recommendation to cancel the automatic payroll pay according to a trained classification model and a feature vector for the employee termination, wherein the trained classification model is trained on prior decisions for cancelling automatic payroll payments for terminated employees and corresponding feature vectors; and
display the recommendation to cancel the automatic payroll pay on a display device.

16. The computer program product of claim 15, wherein the prior decisions for cancelling automatic payroll payments for terminated employees comprise decisions for a plurality of entities, a plurality of states, and a plurality of industries.

17. The computer program product of claim 15, wherein the feature vector for the employee termination comprises at least one attribute selected from a group consisting of a variation index of entity policy for cancelling automatic payments for employees, a termination type for the employee from the entity, a state indicator that indicates a type of state in which the employee is employed, a number of days from a last pay period end date for the employee, a time indicator that indicates time reporting for payroll processing by the employee, a union indicator for the employee, an industry indicator, a group event indicator, seasonal indicator, a weekday indicator.

18. The computer program product of claim 15, wherein the instructions for execution cause the processor to:
map at least one attribute of employment for the employee by the entity to attributes of the feature vector for the employee termination.

19. The computer program product of claim 18, wherein the instructions for execution cause the processor to:
compute a variation index of entity policy for cancelling automatic payments for employees that represent a fraction of prior decisions that cancel automatic pay processing on a date of termination, wherein the date of termination is independent of an end of pay period for the employees.

20. The computer program product of claim 15, wherein the trained classification model comprises a C5 algorithm which classifies attributes of the feature vector of the employee termination into one of two recommendations and the two recommendations include a first recommendation to cancel the automatic payment as of a date of termination and a second recommendation to continue the automatic payment past the date of termination.
